(19) United States
(12) Patent Application Publication
(10) Pub. No.: US 2018/0007862 A1
(43) Pub. Date: Jan. 11, 2018

(54) SYSTEMS, METHODS AND APPARATUS FOR RODENT BEHAVIOURAL MONITORING

(71) Applicant: THE GOVERNING COUNCIL OF THE UNIVERSITY OF TORONTO, TORONTO (CA)

(72) Inventors: ROBERT P. BONIN, MISSISSAUGA (CA); DAVID DUBINS, TORONTO (CA); JEFFREY MOGIL, MONTREAL (CA); IRENE LECKER, TORONTO (CA); ALEKSANDER MERCIK, HAMILTON (CA); ABIGAIL D'SOUZA, BRAMPTON (CA)

(21) Appl. No.: 15/641,468

(22) Filed: Jul. 5, 2017

Related U.S. Application Data
(60) Provisional application No. 62/358,469, filed on Jul. 5, 2016.

(51) Int. Cl. A01K 1/03; G01N 27/22; A01K 29/00

(52) U.S. Cl. CPC A01K 1/031; A01K 29/005; G01N 27/22

(57) ABSTRACT

Systems, methods and devices are provided for the non-invasive behavioural monitoring of rodents within a rodent cage via the detection of interactions with a cage lid. A cage lid interaction sensor, positioned in close proximity to the cage lid, is employed to sense interactions with the cage lid. The resulting signals may be processed to determine a health status of the rodent. In some example embodiments, a lid sensing module is provided in that is configured for attachment to an existing rodent cage, permitting the insertion of the rodent cage into a cage rack after installation of the sensing module. In other example embodiments, a replacement cage lid is provided having an integrated lid interaction sensor and associated detection circuitry. Various example lid sensing modalities and associated sensor configurations are disclosed.

### CROSS-REFERENCE TO RELATED APPLICATION

This application claims priority to U.S. Provisional Application No. 62/358,469, titled “SYSTEMS, METHODS AND APPARATUS FOR RODENT BEHAVIOURAL MONITORING” and filed on Jul. 5, 2016, the entire contents of which is incorporated herein by reference.

### BACKGROUND

The present disclosure relates generally to automated systems for monitoring of rodent behaviour.

Laboratory rodents are by far the most commonly used experimental animal model. A decline in the well-being of rodents can be expressed as impairments in normal behavior and indicate an underlying pathology. Behavioral changes that occur when animals experience pain or illness have been characterized in a number of species and typically include a measure of locomotion, activity, exploration, sleep and feeding. These are multi-parameter assessments that require trained personnel to conduct manual observation, repetitively handle animals and expose animals to novel experimental settings.

In addition to being costly and time consuming, this conventional approach to evaluating animal welfare is inadequate as it: 1) does not provide continuous monitoring, resulting in a lack of data on key rodent activity during the dark phase, 2) exposes rodents to undue anxiety, by taking them out of their homecages and placing them in novel experimental arenas, 3) requires interaction with rodent, which changes their behaviour especially when it comes to pain or distress and 4) often only detects pathology a significant time after its onset, jeopardizing the well-being of the animal and the accuracy of experimental data.

A number of automated, continual monitoring systems using video tracking software or a matrix of infrared beams are currently available for recording rodent behaviour and assessing their well-being. While these systems are a useful experimental tool they are expensive and often require the laboratory animals to be moved from their home cages and placed in special enclosures for monitoring. Studies have shown the importance of monitoring mice in their home-cage to eliminate the stress-induced effects caused by transplanting the animals into specialized test environments. In addition, many of the present systems rely on manual observation or scoring to augment the data gathered from video observation. This increases the potential for processing variations and errors caused by human interaction. In addition, video-based solutions require reliable video recording of the mouse for the duration of the experiment. The quality of video recording will depend on conditions such as adequate lighting and a clear, unobstructed view of the side of the cage, both of which are not easily achieved while the mouse and cage are housed on conventional racks in an animal facility.

### SUMMARY

Systems, methods and devices are provided for the non-invasive behavioural monitoring of rodents within a rodent cage via the detection of interactions with a cage lid. A cage lid interaction sensor, positioned in close proximity to the cage lid, is employed to sense interactions with the cage lid. The resulting signals may be processed to determine a health status of the rodent. In some example embodiments, a lid sensing module is provided in that is configured for attachment to an existing rodent cage, permitting the insertion of the rodent cage into a cage rack after installation of the sensing module. In other example embodiments, a replacement cage lid is provided having an integrated lid interaction sensor and associated detection circuitry. Various example lid sensing modalities and associated sensor configurations are disclosed.

Accordingly, in a first aspect, there is provided a sensing module for use with a rodent cage for monitoring interactions of a rodent with a cage lid of the rodent cage, said sensing module comprising:

a lid interaction sensor configured to produce signals associated with interactions of the rodent with the cage lid; and

detection circuitry operably coupled to said lid interaction sensor for detecting the signals produced by said lid interaction sensor;

securing means for securing said detection circuitry and said lid interaction sensor to the rodent cage such that said lid interaction sensor is located proximal to the cage lid; and

wherein said detection circuitry is connectable to a power source for providing power thereto.

In another aspect, there is provided a sensorized cage lid configured for use with a rodent cage for behavioural monitoring of a rodent, the sensorized cage lid comprising:

a lid body configured to contact a lower cage portion of the rodent cage, the lid body replacing a non-sensorized lid of the rodent cage;

a lid interaction sensor supported by said lid body, wherein said lid interaction sensor is configured such that when said lid body received by the lower cage portion, said lid interaction sensor produces signals associated with interactions of the rodent with said lid body; and

detection circuitry supported by said lid body and operably coupled to said lid interaction sensor for detecting the signals produced by said lid interaction sensor;

wherein said detection circuitry is connectable to a power source for providing power thereto.

In another aspect, there is provided an apparatus for behavioural monitoring a rodent, the apparatus comprising:

a rodent cage comprising:
a lower cage portion configured to house a rodent therein; and
a cage lid configured to be received by said lower cage portion;

a lid interaction sensor configured to produce signals associated with interactions of the rodent with said cage lid; and

detection circuitry operably coupled to said lid interaction sensor for detecting the signals produced by said lid interaction sensor, wherein said detection circuitry is supported by said rodent cage;

wherein said detection circuitry is connectable to a power source for providing power thereto.

In another aspect, there is provided a system for performing behavioural monitoring of a plurality of rodents, the system comprising:

a cage rack;

a plurality of rodent cages housed within said cage rack, each rodent cage comprising:
a lower cage portion;
a cage lid;
a lid interaction sensor supported by one or both of said lower cage portion and said cage lid, wherein said lid interaction sensor is configured to produce signals associated with interactions of a given rodent with said cage lid; and
detection circuitry operably coupled to said lid interaction sensor for detecting the signals produced by said lid interaction sensor, wherein said detection circuitry is connectable to a power source for providing power thereto.

In another aspect, there is provided a method of performing behavioural monitoring of a rodent within a rodent cage comprising a cage lid, the method comprising:

detecting, with a lid interaction sensor proximally positioned relative to the cage lid, signals responsively produced based on interactions of the rodent with the cage lid; and

processing the signals to infer one or more behavioural measures associated with behaviour of the rodent.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIGS. 1A-C illustrate example rodent cages and cage systems.

FIGS. 2A-D illustrates an example embodiment of a sensing module that may be employed with an existing rodent cage.

FIG. 3 shows various example alternative mounting configurations for supporting the sensing module.

FIG. 4 is a block diagram illustrating the components of an example lid interaction sensing device, and an associated remote computing device.

FIGS. 5A-5B show an example embodiment of a capacitance-based lid interaction sensor.

FIG. 5C shows example lid interaction measurements obtained using a capacitive lid interaction sensor.

FIGS. 6A-6C illustrate an example implementation of a capacitance-based lid interaction sensor employing surface or projected capacitance measurement.

FIG. 7 illustrates an example of a cage lid having multiple conductive regions for spatially resolved lid interaction detection.

FIG. 8 illustrates an example embodiment employing a temperature detector for sensing cage lid interactions.

FIG. 9 illustrates an example embodiment employing a force/pressure detector for sensing cage lid interactions.

FIGS. 10A-B illustrate various example embodiments employing optical detection modalities for sensing cage lid interactions.

FIG. 11 illustrates an example embodiment employing a vibration sensing detector for sensing cage lid interactions. FIG. 12 illustrates an example embodiment employing an inductive proximity detector for sensing cage lid interactions.

FIG. 13 is a flow chart illustrating an example method of detecting and processing signals associated with the interactions of a rodent with a lid interaction sensor.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As used herein, the term “cage lid” refers to a removable structure that contacts a lower cage portion in order to confine a rodent, such that vertical travel of the rodent is limited. In some example implementations, a cage lid may define the uppermost portion of a rodent cage. In other example embodiments, one or more additional structures may be provided above or on a cage lid, such as a filter and/or a lid cover.

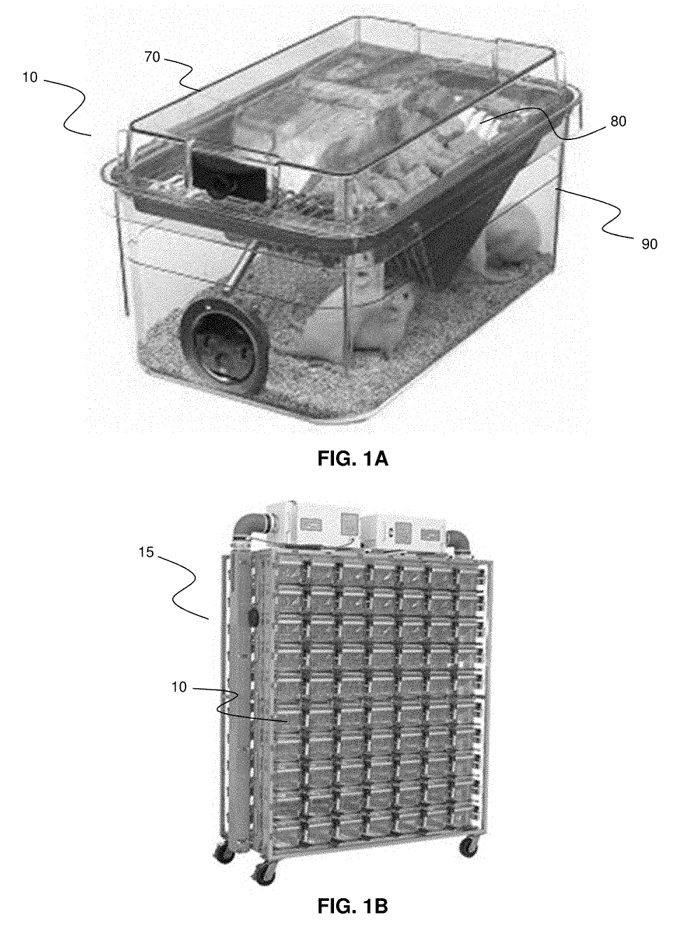

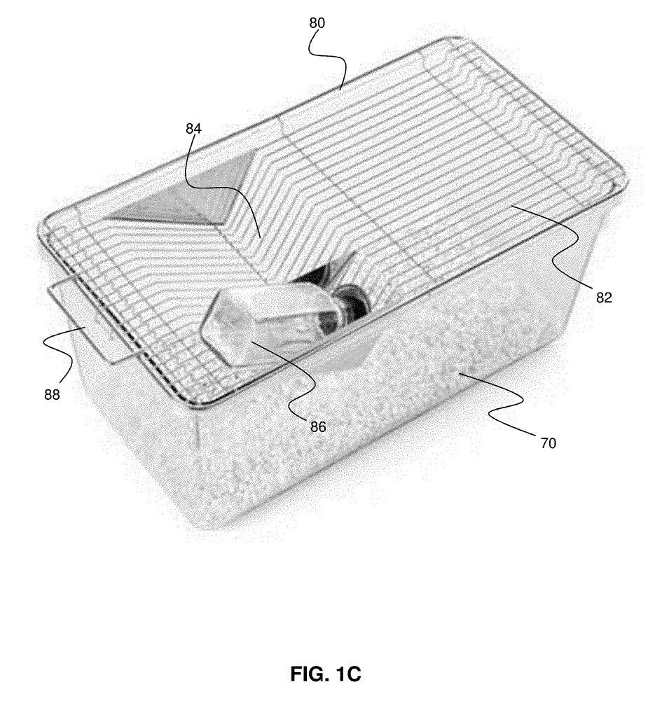

In a research animal facility, rodents are typically housed in rectangular cages covered with a lid. An example of such a rodent cage is shown in FIG. 1A. The example rodent cage 10 includes several components, including a lower cage portion 90 in which rodents are housed, a wire cage lid 80, and a cover 70. Rodent cages such as the example rodent cage of FIG. 1A are typically housed in a cage rack. FIG. 1B shows an example cage rack 15 housing a plurality of rodent cages 10.

The view of the cage lid 80 is partially obstructed in FIG. 1 A due to the presence of feed item and a bottle that are supported by the wire cage lid 80. FIG. 1C shows an example rodent cage with the cover and feed removed, with the wire cage lid 80 clearly visible. The example cage lid 80 is shown supported on the lower cage portion 90, thus confining the rodent and forming a ceiling of the cage environment. The example cage lid 80 is formed as a stainless steel grid of wires 82 having recessed regions 84 to hold items such as food and water. FIG. 1C shows a water bottle 86 supported in one such recessed region. Rodents interact with the cage lid when they consume food or water, and they can also spend a considerable amount of time hanging from the cage lid or touching it while rearing. The cage lid 80 may include a handle 88 for removal thereof.

The present inventors have discovered that interactions of a rodent with the cage lid can be employed to infer a behavioural status and/or health status of the rodent. For example, the inventors have found that a reduction in the frequency of cage lid interaction is indicative of pain or distress in animals. Additionally, hanging and eating behaviours have been observed to be affected by the physiological state of the rodent, as seen by the loss of weight and reduced activity and food consumption of mice with cancer or given chemotherapeutic drugs. These results reveal that cage interaction provides a measure that is well correlated with rodent well-being, and that cage interaction measures may be employed for the early detection of disease.

Accordingly, as described in detail below, the present disclosure provides example systems, methods and devices that employ lid interaction for the behavioural monitoring of rodents. In contrast to known rodent monitoring systems and devices, the example embodiments described herein may be employed to permit the nonintrusive monitoring of rodents in their cages, thereby enabling the automated and continuous assessment of rodent welfare, while minimizing or eliminating disruptive manual observation, illumination, and handing. The example lid interaction embodiments described here, and variations thereof, can be employed in a wide range of applications, including, but not limited to, pre-clinical research including drug discovery and safety assessment.

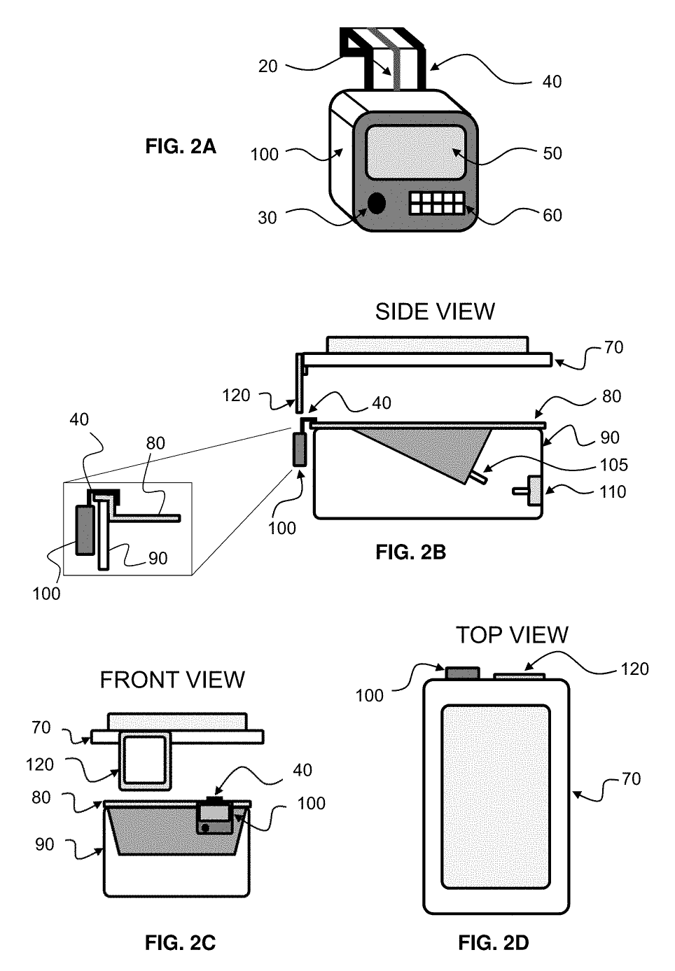

FIGS. 2A-2D illustrate a non-limiting example embodiment of a sensor module for use with a rodent cage. As shown in FIG. 2A, the example the sensor module includes a housing 100 (e.g. a plastic case) and a support member 40 that is configured to attach the sensor module to a standard rodent cage. The housing includes detection circuitry that is operably connected to a lid sensor 20. FIG. 2B illustrates additional cage features that may optionally be included, such as a water spout 110 connected to a water system in the holding rack which automatically dispenses drinking water for the rodents, and a protruding spout 105 of a water bottle supported by the wire cage lid 80.

In the present example embodiment, the lid interaction sensor 20 is shown as a conductive wire that extends from the housing 100 to electrically contact the wire cage lid 80 when the support member 40 is secured over the wire cage lid 80. As described in detail below, the detection circuitry is provided to perform capacitive sensing of contact between a rodent and the conductive cage lid 80. It will be understood that the illustrated capacitance sensor provides but one example of a wide range of sensing mechanisms that may be employed to detect interactions of a rodent with the cage lid. Many additional example lid interaction sensing embodiments are described below.

As can be seen in FIGS. 2A-D, the support member 40 is shaped to allow the housing 100 to hang outside the cage, adjacent to a front wall of the rodent cage, and beside a cage card 120 that specifies the relevant animal information such strain, date of birth, etc. (the cage card 120 is shown as being supported by the cage cover 70). Accordingly, both the housing 100 and the cage card 120 are visible to caretakers when the rodent cage is housed within a cage rack, without the need to remove the cage from the cage rack.

The support member 40 may be provided as a protruding plastic handle or hook that enable the connection of the sensing module to the cage lid 80 (or to the lower cage portion 90). In example implementations in which the cage lid is a magnetically responsive metal (such as ferritic stainless steel), the support member 40 may include one or more magnets (e.g. magnetic strips) that enable the sensing module to be securely connected to the cage lid and stabilize it in place. As noted above, in the present example embodiment, the support member 40 includes a metal wire 20 which will resides on a lower portion of the support member 40 such that electrical contact is made between the metal cage lid 80 and the metal wire 20.

As shown in FIG. 2A, the housing may optionally include one or more of an on/off button 30, a control panel 60, and a display screen 50. The sensing module may have an internal power source (a battery), or alternatively, the sensing module may be connectable to an external power source. As described below, the sensing module may include a wireless transmitter for wirelessly transmitting signals and/or processed data to a remote computing device. Alternatively, the sensing module may be interfaced with a remote computing device through a wired connection.

It is noted that the example sensing module shown in FIGS. 2A-D is compatible with existing rodent cage systems, such that the sensing module may be installed (attached, connected retrofitted) to an existing rodent cage without requiring modifications or the purchase of a new rodent cage. Furthermore, the sensing module is connectable to the rodent cage such that after installation of the sensing module, the rodent cage may be inserted into a rodent cage rack without mechanical interference between the side walls of the cage rack and components of the sensing module. This aspect of the example sensing module permits the continuous monitoring of rodent behaviour while the rodent cage is housed in a cage rack, thereby enabling continuous and nonintrusive behavioural monitoring.

Furthermore, it will also be understood that the example embodiments shown in FIGS. 2A-D and elsewhere in the present disclosure that relate to research-grade rodent cages, having wire frame lids, are not intended to limit the scope of the present disclosure to such specific configurations of rodent cages. Indeed, various embodiments disclosed herein may be applied or adapted to a wide range of cage types and cage lid configurations. For example, an alternative cage lid may be employed, in which the cage lid is not electrically conductive. In such cases, a non-capacitive transduction modality may be selected for the lid interaction sensor, such as, but not limited to, modalities that employ optical signals, magnetic signals, and force (e.g. pressure/strain) measurements.

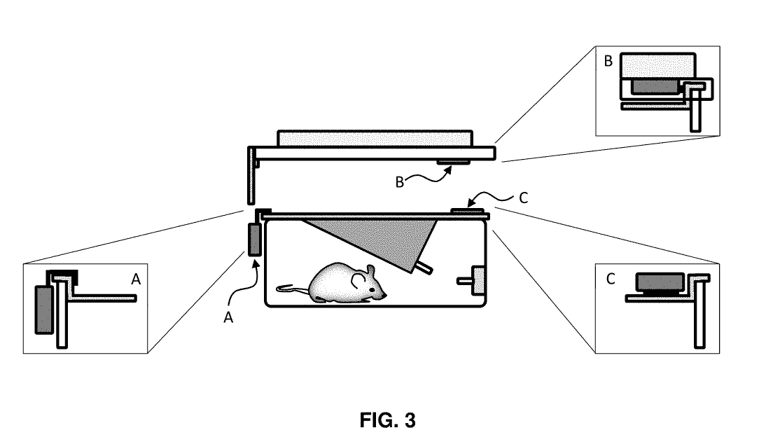

Although FIGS. 2A-D show an example implementation in which the housing and detection circuity 100 are housed at the front of the rodent cage, adjacent to a front wall of the lower cage portion 90, it will be understood that many other attachment and support locations and methodologies may alternatively be employed. For example, FIG. 3 illustrates three different example attachment strategies for mounting or securing the sensing module to the rodent cage, including (A) adjacent to the front of the cage, as per FIGS. 2A-D, (B) attachment to an inner surface of a cage cover, and (C) attachment within a recessed portion of the cage lid. Non-limiting examples for the attachment of the sensing module to a portion of the rodent cage include the use of a clip, adhesives, suction devices, velcro, and magnetic strips.

In the example embodiments illustrated in FIGS. 2A-D and FIG. 3, the sensing module is disclosed being attachable to an existing rodent cage, thereby providing a retrofitted sensor module that does not necessitate the purchase of a new rodent cage. In an alternative example embodiment, the lid interaction sensor and detection circuitry (and optionally other components, such as a display) may be integrated into the design of one or more components of a rodent cage, thereby providing a sensorized rodent cage, or sensorized component of a rodent cage. In one example implementation, a sensorized lid for a rodent cage may be provided in which the one or more lid interaction sensors and the associated detection circuitry are supported by a lid body, where the sensorized lid may be used with an existing lower cage portion of a rodent cage. In another example implementation, one or more lid interaction sensors and the associated detection circuitry may be integrated with the lower cage portion of a rodent cage.

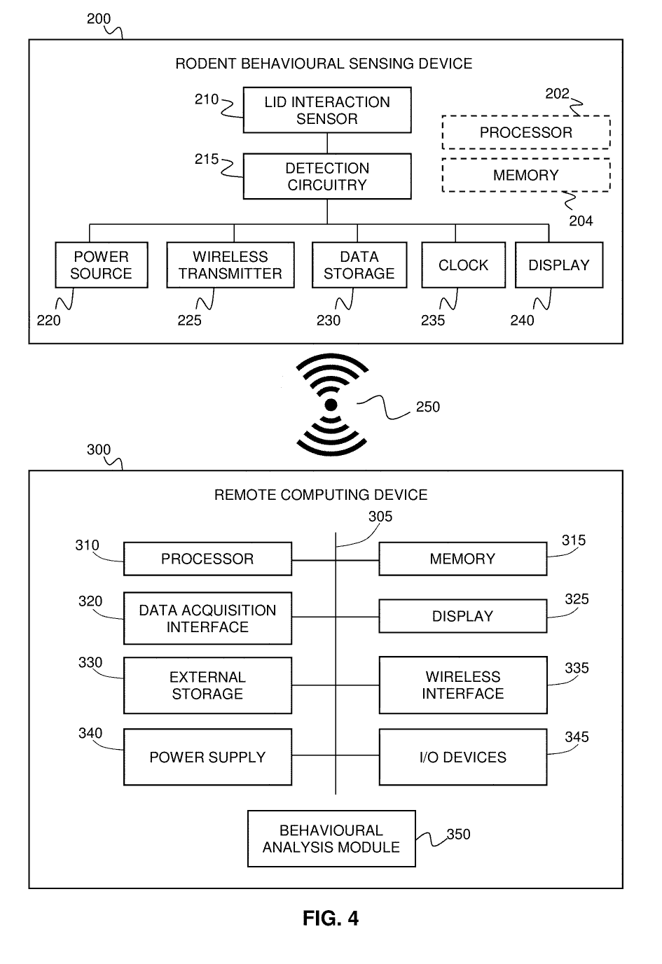

Referring now to FIG. 4, an example system is shown for performing behavioural monitoring via lid interaction detection. The system includes a rodent behavioral sensing device 200 including a lid interaction sensor 210. The lid interaction sensor may be provided according to any suitable detection modality, such as, but not limited to, capacitance detection, optical detection, vibration detection, displacement detection, and thermal detection. The rodent behavioural sensing device 200 may be provided as a sensing module that is configured to be interfaced and supported by an existing rodent cage, for example, as illustrated in FIGS. 2A-D. Alternatively, the rodent behavioral sensing device may be integrated into one or more components of a rodent cage, as described below.

As shown in FIG. 4, the lid interaction sensor 210 is interfaced with detection circuitry 215 that detects signals responsively generated by the lid interaction sensor when a rodent interacts with the cage lid. It will be understood that the selection of suitable detection circuitry 215 will depend on the detection modality of the lid interaction sensor, and an example of suitable detection circuitry is shown below in the example case of a capacitive detection modality. The detection circuitry (and optionally other components of the behavioural sensing device, such as the optional display 240) is powered by a power source 220, which may be included in the rodent behavioural sensing device 200 (e.g. as a battery) or alternatively the detection circuitry may be connected to a remote power supply. A local data storage 230 (e.g. flash memory) may be included, although in some example embodiments, the detected signals may be transmitted to a remote computing device 300 without local storage. A clock 235 may be employed to generate time stamps associated with the measured signals. A display 240, such as a LCD or LED display, may be included in order to display information associated with any one or more of the status of the rodent behavioural sensing device 200, error codes associated with the operation of the rodent behavioural sensing device 200, health status or behavioral status of the rodent as per the processing signals, identifying information pertaining to the rodent and/or rodent cage, and alerts related to the rodent behavioural sensing device 200 or the status of the rodent.

In some embodiments, the rodent behavioural sensing device 200 includes a local processor 202 and associated memory 204 for locally processing the detected signals in order to infer a behavioural and/or health status of the rodent without requiring remote processing. Alternatively, as shown in FIG. 4, the rodent behavioural sensing device 200 may be configured to interface with a remote computing device 300 that performs remote processing of the detected lid interaction signals. In the example embodiment shown in FIG. 4, the rodent behavioural sensing device 200 and the remote computing device 300 are interfaced via wireless signals 250 transmitted from a wireless transmitter 225 of the rodent behavioural sensing device 200 to a wireless receiver 335 of the remote computing device. Alternatively, the rodent behavioural sensing device 200 may be connected or connectable to the remote computing device 300 through one or more cables.

It is also noted that the rodent behavioral sensing device may optionally be configured to receive data transmitted by the remote computing device. For example the rodent behavioral sensing device may include a wireless receiver, or a wireless transceiver. Such an implementation of a rodent behavioural sensing device may be beneficial when the detected signals are processed remotely by the remote computing device 300, such that behavioural or health status information that is obtained based on the processed lid interaction signals may be transmitted back to the rodent behavioural sensing device for display on a local display 240 associated therewith.

In some example embodiments, the remote computing device 300 is configured to interface with a plurality of rodent behavioural sensing devices, such as an array of such devices housed in one or more cage racks. For example, the connections between the rodent behavioural sensing devices and the remote computing device 300 may be implemented via a wireless network, such as Wifi or Bluetooth. In another example implementation, a plurality of rodent behavioural sensing devices may be interfaced with the remote computing device 300 via a wired network, such as Ethernet or variants thereof.

FIG. 4 also illustrates an example implementation of the remote computing device 300, which includes one or more processors 310 (for example, a CPU/microprocessor), bus 305, memory 315, which may include random access memory (RAM) and/or read only memory (ROM), a data acquisition interface 320, a display 325, external storage 330, one more communications interfaces 335, a power supply 340, and one or more input/output devices and/or interfaces 345 (e.g. a speaker, a user input device, such as a keyboard, a keypad, or a mouse).

It is to be understood that the example system shown in FIG. 4 is illustrative of a non-limiting example embodiment, and is not intended to be limited to the components shown. Furthermore, one or more components of the rodent behavioural sensing device and/or the remote computing device 300 may be provided as external components that are externally interfaced. Although only one of each component is illustrated in FIG. 4, any number of each component can be included in the remote computing device 300. For example, a computer typically contains a number of different data storage media. Furthermore, although bus 305 is depicted as a single connection between all of the components, it will be appreciated that the bus 305 may represent one or more circuits, devices or communication channels which link two or more of the components. For example, in personal computers, bus 335 often includes or is a motherboard. The remote computing device 300 may include many more or less components than those shown.

The remote computing device 300 may be implemented as one or more physical devices that are coupled to processor 310 through one of more communications channels or interfaces. For example, the remote computing device 300 can be implemented using application specific integrated circuits (ASICs). Alternatively, the remote computing device 300 can be implemented as a combination of hardware and software, where the software is loaded into the processor from the memory or over a network connection.

Some aspects of the present disclosure can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version. Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's) and field-programmable gate arrays (FPGAs).

A computer readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices. In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., compact discs (CDs),digital versatile disks (DVDs), etc.), among others. The instructions can be embodied in digital and analog communication links for electrical, optical, acoustical or other forms of propagated signals, such as carrier waves, infrared signals, digital signals, and the like. As used herein, the phrases “computer readable material” and “computer readable storage medium” refer to all computer-readable media, except for a transitory propagating signal per se.

Embodiments of the present disclosure can be implemented via processor 310 and/or memory 315. For example, the functionalities described below can be partially implemented via hardware logic in processor 310 and partially using the instructions stored in memory 315. Some embodiments are implemented using processor 310 without additional instructions stored in memory 315. Some embodiments are implemented using the instructions stored in memory 315 for execution by one or more microprocessors, which may be general purpose processors or specialty purpose processors. Thus, the disclosure is not limited to a specific configuration of hardware and/or software.

As noted above, the remote computing device 300 may be employed for the remote processing of lid interaction signals detected by rodent behavioural sensing device. The remote computing device 300 may be programmed with subroutines, applications or modules, which include executable instructions, which when executed by the one or more processors 310, causes the system to perform one or more methods described in the present disclosure. Such instructions may be stored, for example, in memory 315 and/or other internal storage. In particular, in the example embodiment shown, behavioural analysis module 350 includes executable instructions for processing the detected lid interaction signals in order to infer, estimate, predict or otherwise determine one or more measures associated with the behavioral and/or health status of the rodent.

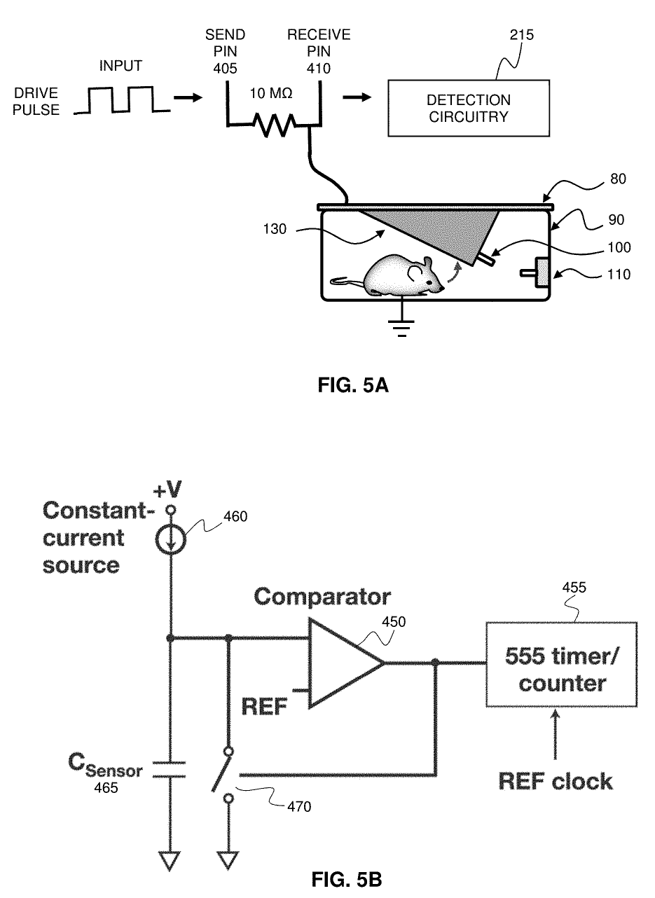

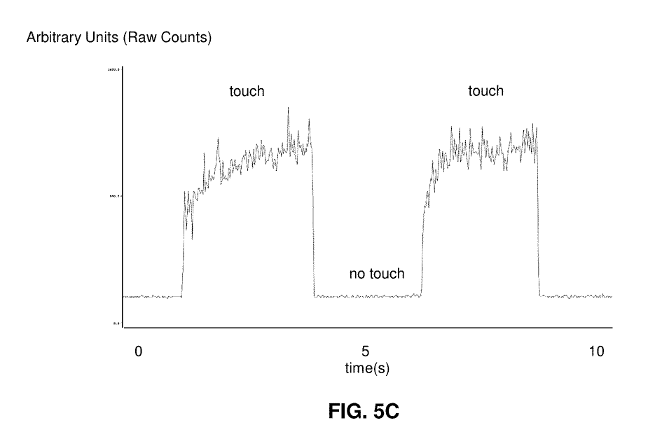

Referring now to FIG. 5A, an example lid interaction sensing embodiment is illustrated in which the lid sensing modality involves capacitance detection. The lid interaction sensor component employed in this example embodiment is a capacitance-touch switch that utilizes one electrode to function. The switch works by using the cage lid as the first half of the capacitor and the body capacitance of the rodent, which is electrically-conductive and therefore can store electrical charge, as the second half of the capacitor. When the rodent contacts the cage lid, it increases the capacitance and triggers the switch. The system is based on a simple RC circuit (Resistor-Capacitor), shown in FIG. 5A, in which the resistor 400 charges a capacitor in TC seconds, where TC=Resistance (ohms)* Capacitance (farads). The voltage at 1 Time Constant (TC) equals 63.2% of the charging voltage.

As shown in FIG. 5A, the device uses two pins (sender 405 and receiver 410) which can be in one of two electrically different states. The two states are the input state, which has high impedance (resistance), and the output state, which has low impedance and can provide the sink (negative voltage) to direct the charge. When a square pulse is sent from the device, the send pin is converted to a new state and then waits for the receive pin to change to the same state. This allows the measure of the time it takes for the square pulse signal to travel from the send pin to the receive pin, which will be computed in arbitrary units which can then be converted to units of time. The delay between the send pin changing state and the receive pin changing to the same state as the send pin will be determined by an RC time constant, defined by R*C, where R is the value of the resistor 400 and C is the capacitance at the receive pin, plus any other capacitance (e.g. rodent interacting with the cage lid) present at the sensor (receive) pin. A higher value resistor provides a significantly low drain time and additional small capacitors (20-400 pF) in parallel with the rodent's capacitance to stabilize the sensed readings. An additional wire may be employed from the device to the metal housing rack or another suitable structure external to the device and cage to provide an external reference ground to reduce static charge buildup and facilitate signal analysis.

FIG. 5B shows a schematic of a circuit for measuring capacitance using a comparator 450 and 555 counter/timer 455. A constant-current source continuously 460 charges the capacitive sensor to the reference threshold level on the comparator 450. The comparator 450 will pulse high each time the capacitive sensor 465 reaches the reference threshold level. This closes the switch 470, discharges the capacitor 465 and resets the counter 455. Determining when the user is in contact with a sensor is achieved by counting the number of clock cycles that it takes for the capacitive sensor to charge up to the reference level (REF) on the comparator. This value is then compared with preset threshold detection settings. For example, a count of 50 could indicate sensor contact, whereas a count value of less than 50 would indicate no contact. FIG. 5C provides examples of the detected signals from the capacitance sensor shown in FIG. 5A.

FIG. 5C shows a sample of real sensor data from an example device formed according to the present capacitive sensing embodiment. The device converts the data from the sensor into a digital count, called raw count. Processing of the raw count results in ON/OFF states for the sensor which is interpreted as either a TOUCH or NO TOUCH state based on a threshold value.

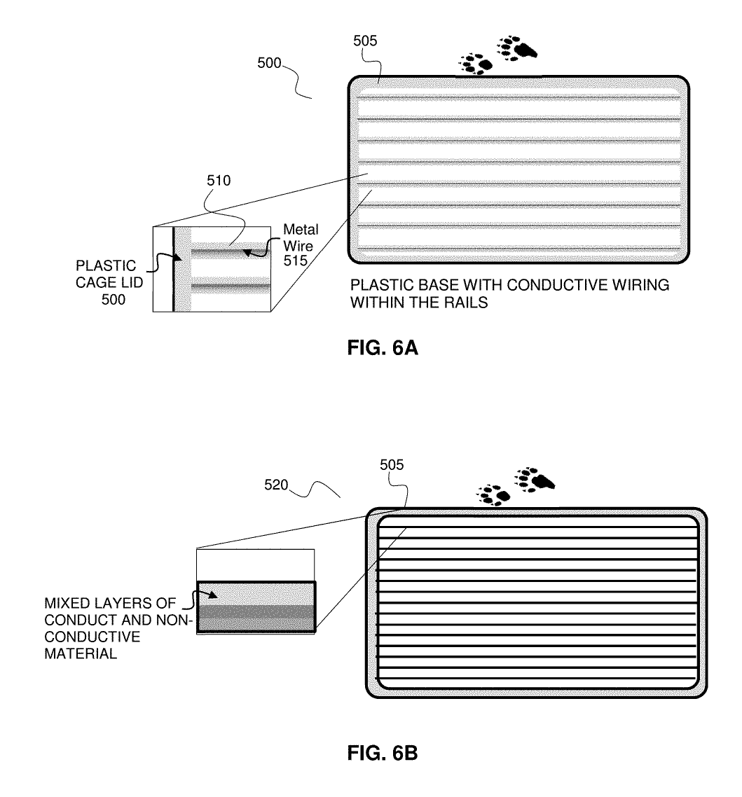

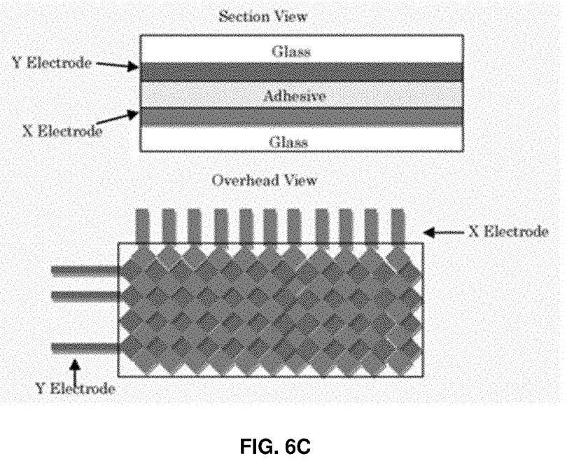

It is noted that both the direct contact and proximity of a rodent to the cage lid can generate capacitance signals indicative of rodent interaction with the cage lid. For example, the proximity of the rodent to the lid will also change the time taken for the receive pin to change state because the rodent has a charge, and the proximity of the rodent's charge affects the timing of the charge to change state. Accordingly, a capacitive sensing device could distinguish between the two signals (contact vs. close proximity) as direct contact produces a larger signal. Accordingly, in some example implementations, both contact with the cage lid, and proximity to the cage lid, could be detected and processed. FIGS. 6A-B illustrate other example embodiments in which capacitance is employed for lid interaction sensing. For example, capacitive sensing can also be achieved using surface capacitance measurement or projected capacitance measurement. In surface capacitance, the measurement can be performed by the application of voltage to a sensor in the metal grid of the cage, which creates a uniform electrostatic field. FIG. 6A illustrates an example embodiment in which a plastic cage lid 500 is formed having an outer plastic perimeter 505 and a set of plastic rails 510 having embedded conductive wires 515. In this configuration the metal grid acts as the electrode layer and it is covered by a thin protective plastic layer. Electric voltage is applied to electrodes positioned in the four corners of the glass substrate, generating a uniform low-voltage electrical field across the entire panel. The coordinates of the position at which the mouse touches the grid is identified by measuring the resulting changes in electrostatic capacity at the four corners of the panel. When the rodent comes into contact with, or close proximity to, the cage lid 500, (and hence the electrostatic field) a capacitor is formed dynamically, as shown in FIG. 6A.

Projected capacitance is another form of capacitive sensing that is typically used for touch screen applications. FIG. 6B shows an example implementation of a cage lid 520 that is configured for interaction sensing via projected capacitance. In this implementation the grid of the cage lid is composed of conductive and non-conductive materials, where the cage lid includes a grid composed of X-Y electrodes covered in non-conductive material, as shown in the detailed view. When a rodent is in close proximity to the cage lid, it alters the electric field to add an additional capacitance (Cf) to the sensor, which can be measured by the capacitive sensor controller. Once a pre-determined increase in capacitance is measured, the sensor is considered activated.

FIG. 6C shows the typical composition of a projected-capacitance-based sensor. A layer of non-conductive coating surrounds an X and Y electrode which are separated by adhesive material. The X and Y electrode are arrange in perpendicular layers forming a conductive X-Y grid of electrodes (typically composed of indium tin oxide material). The capacitance is measured (usually by scanning the rows and columns over time) to locate one (or more) interaction incidences within the X-Y grid space. The sensor forms an intrinsic parasitic capacitance (Ci) by coupling with the surrounding ground pattern on the printed circuit board.

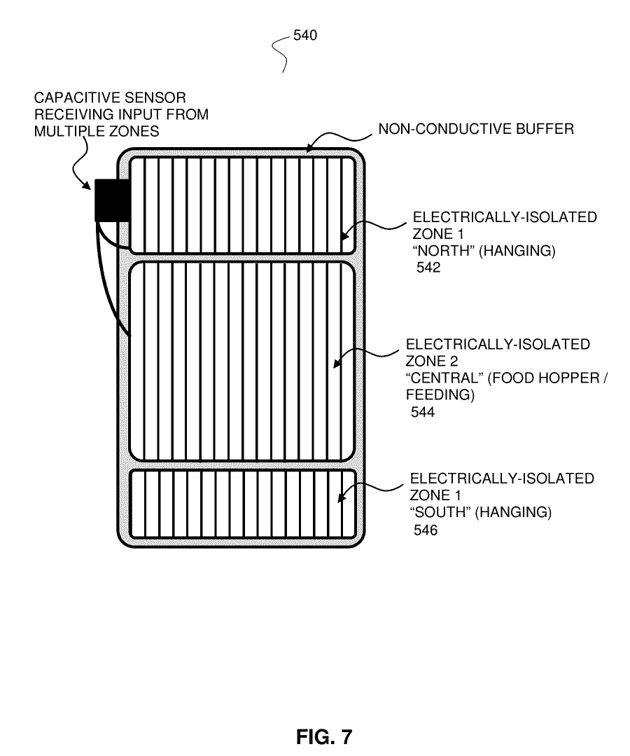

In some example embodiments, the cage lid may be configured to enable detection of cage lid interactions in several different zones for spatially resolved behavioural analysis. For example, as shown in FIG. 7, a metal cage lid 540 can be modified to consist of two or more electrically-isolated zones or regions 542-546. These regions may be correlated spatially with regions within the rodent cage in which the rodent is known or expected perform distinct behaviours. As shown in the example illustrated in FIG. 7, the “central” region 544 in which food is placed (“central”) can be isolated from the surrounding “north” 542 and “south” 546 parts of the cage lid. This enables capacitive measurement of interactions with the central region associated with feeding to be easily separated from interaction with the north 542 and south 546 regions that are typically indicative of hanging.

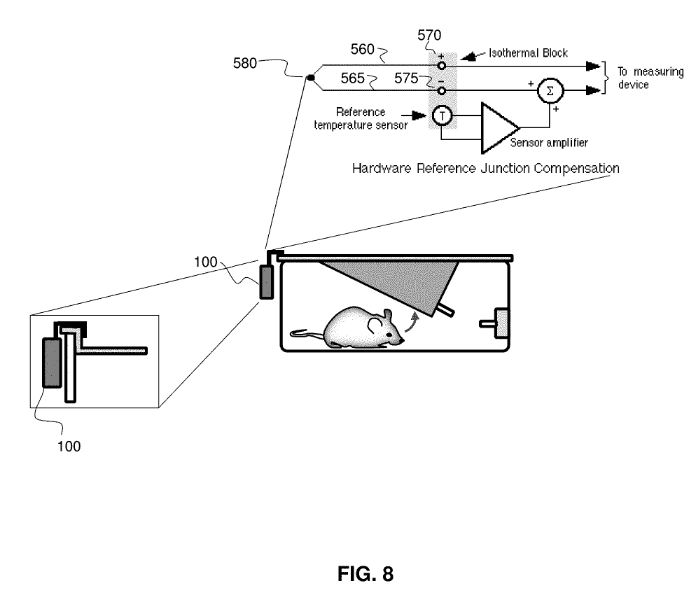

Although the preceding example lid interaction sensing device was described in the example context of capacitance sensing, it will be understood that a wide variety of detection modalities may be employed for the transduction of lid interaction into a measurable signal. For example, as shown in FIG. 8, a sensor that is responsive to temperature, such as a thermocouple, RTD, thermistor or IC sensor, may be employed to detect the interaction of a rodent with a cage lid if the temperature sensor is located proximal to the cage lid. In the figure, the two lines 560 and 565 respectively connected to the positive 570 and negative 575 terminals are two different types of metals. The black dot 580 at the tip of those lines will be touching the cage lid and act as the sensor. The detection circuitry may be position to reside outside of the cage, as shown in the figure.

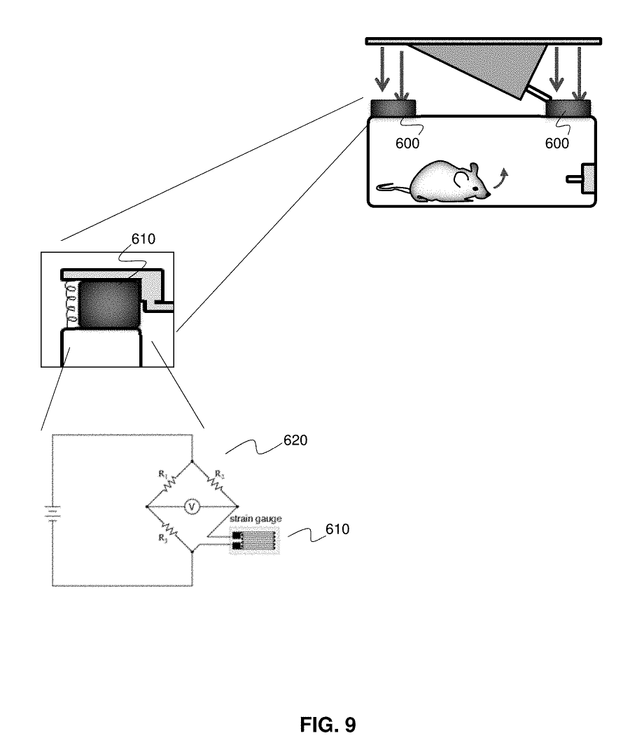

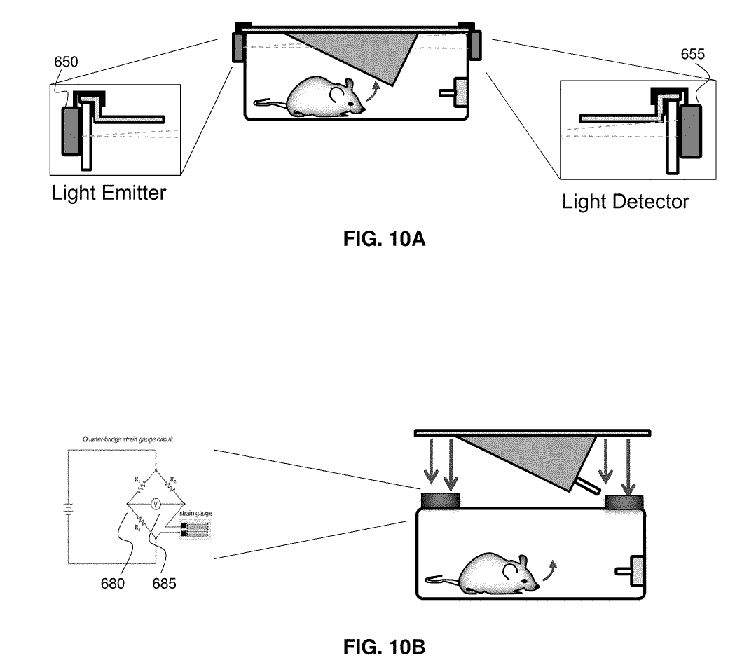

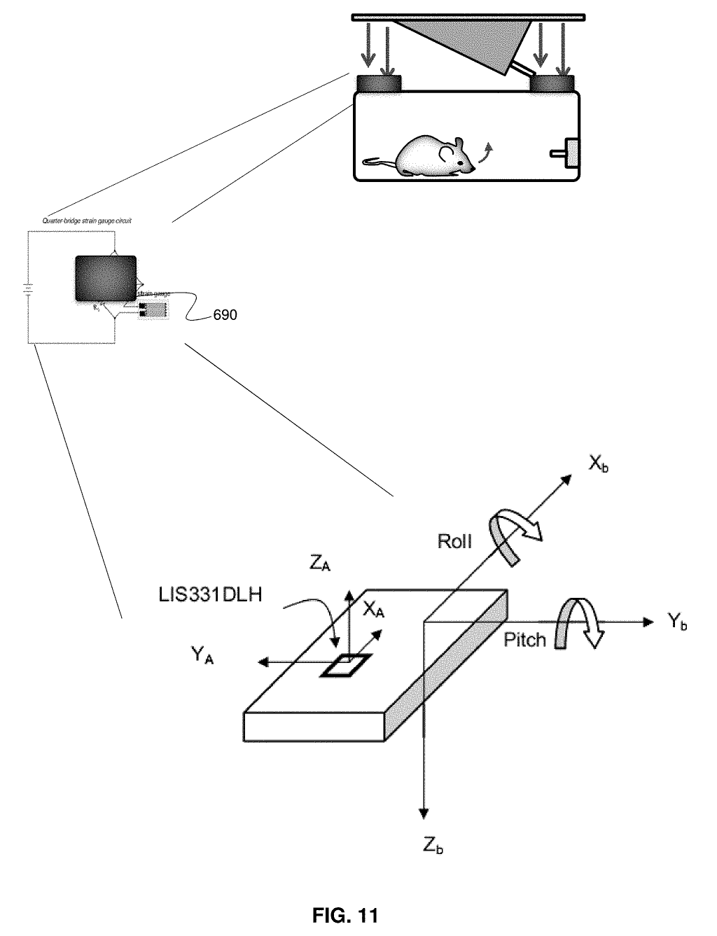

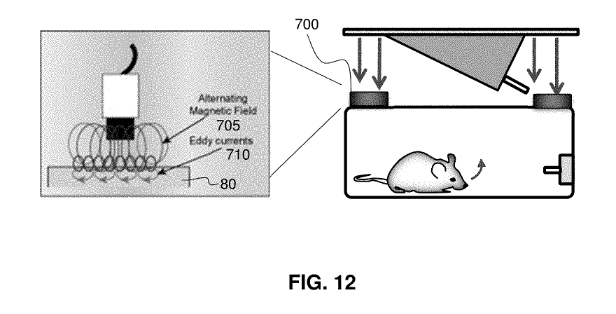

FIG. 9 illustrates an alternative example implementation in which one or more pressure/force sensors 600 are employed for lid interaction sensing (the spring shown in the figure, and in FIGS. 10B and 11, is included to illustrate the elastic motion of the cage lid). For example, a plurality of strain gauge based load cells may be disposed in order to permit the measurement of the weight of the rodent and optionally the weight of the cage lid. As shown in the figure, the cage lid rests on the strain gauge 610. When the rodent touches the lid, the detection circuitry 620 will detect a change related to the stress value applied on the sensor. As the signal value is small, (typically a few millivolts) the signal conditioning electronics provides amplification to increase the signal level to a suitable level for application to external data collection systems.

FIG. 10A illustrates an optical-based modality for performing lid interaction sensing. A light beam is projected from a light source 650 (such as an LED) proximal to the cage lid (e.g. in a plane parallel and proximal to the cage lid) and detected with a detector 655, whereby a loss of detected signal due to a break in the beam is indicative of the presence of the rodent proximal to the cage lid. The incorporation of several light sources and detectors would enable detection of rodent interaction with distinct and separate zones of the cage lid for the determination of hanging and/or feeding behaviour associated with the identified cage lid zones.

In some example embodiments, the cage lid may be elevated from the cage, for example, using springs, rubber feet, or other flexible substrate to permit the cage lid to move or vibrate when the mouse interacts with it, the vibrations or movement of which may be detected and processed. Movement of the cage lid may be also detected using optical methods. For instance, the device could incorporate a laser and light sensor for the use of triangulation, Moire, diffraction or holographic principles to detect movement of the cage lid associated with mouse interaction with the cage lid.

FIG. 10B shows the use of light emitted from an LED or laser light source to measure movement or displacement of the cage lid associated with cage lid interaction. In FIG. 10B, laser vibrometers or laser velocimeters are used to measure the displacement of the cage lid. The standard laser Doppler vibrometer is a non-contact velocity transducer working on the principle of measuring the Doppler frequency shift of a laser beam scattered from a moving target by means of an interferometer. The on-board electronics converts the Doppler signal to an analog voltage proportional to the instantaneous velocity of the target. The combination of an interferometer with two moving mirrors driven by galvanometric actuators makes it possible to direct the laser beam to the desired measurement points. Such an instrument, named the scanning laser Doppler vibrometer, can quickly perform a series of velocity measurements on a grid of points over the structure under test. In FIG. 10D, a frequency-modulated laser beam generated by source 680 is reflected from the vibrating surface (cage lid). The reflected beam is then detected by detector 685 and the detected modulation frequency is compared with the frequency of the incident beam, and the Doppler frequency shift is used to calculate the velocity of the vibrating surface. The vibration amplitude and frequency are extracted from the Doppler shift of the reflected laser beam frequency and the output is generally a continuous analog voltage that is directly proportional to the target velocity component along the direction of the laser beam.

Movement of the cage lid may also be accomplished via one or more vibration sensors, such as an accelerometer 690, placed beneath the cage lid, as shown in FIG. 11. In other example embodiments, cage lid movement may be detected using detection modalities such as linear variable differential transformer to measure linear displacement of the cage lid; sense-coils, Hall effect, magnetoresistive or magnetoinductive read heads to detect movement of the cage lid; or other electrical or mechanical devices that may be incorporated to detect or measure vibrations or displacement of the cage lid.

FIG. 12 illustrates another example embodiment in which a proximity sensor 700 is employed to detect vibrations of the cage lid using non-contact sensors which measure the distance of the cage lid from the detector. The non-contact sensors may employ, for example, detection modalities that use magnetic, electric or optical distance sensing. For instance, an eddy-current proximity sensor can operate by generating an electromagnetic field and detecting the eddy current losses generated when the metal cage lid enters the field. The sensor 700 consists of a coil on a ferrite core, an oscillator, a trigger-signal level detector and an output circuit. An alternating current in the sensing coil creates an alternating magnetic field 705 which induces small eddy currents 710 in the metal cage lid 80. The eddy currents 710 create an opposing magnetic field which resists the field being generated by the probe coil. The interaction of the magnetic fields is dependent on the distance between the sensor 700 and the cage lid 80. As the distance changes, the electronics sense the change in the field interaction and produce a voltage output which is proportional to the change in distance between the sensor and the cage lid.

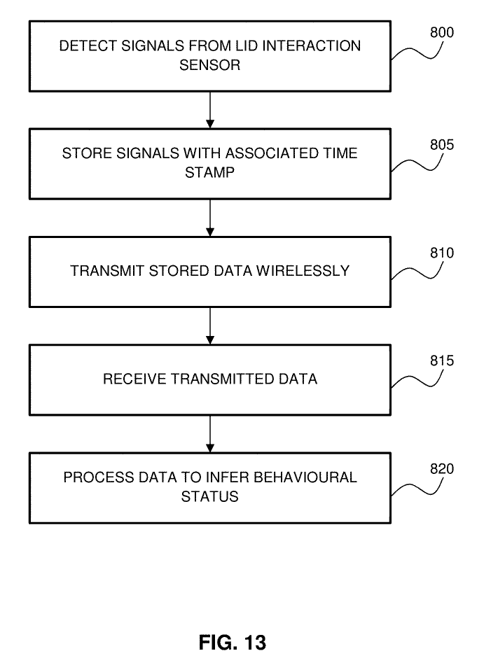

Referring now to FIG. 13, an example flow chart is shown illustrating the detection and processing of lid interaction signals. In step 800, lid interaction signals, responsively generated by the lid interaction sensor when a rodent interacts with a lid, are detected by the detection circuitry of a rodent behavioral sensing device. The detected signals may be optionally paired (e.g. stored) with a time stamp, as shown at step 805. The detected signals (optionally with time stamp information) may then be transmitted (e.g. wirelessly) to a remote computing device at step 810, with the signals optionally be pre-processed by the detection circuitry or additional processing circuitry associated with the rodent behavioural sensing device. The transmitted signals are then received by the remote computing device at step 815, and processed at step 820 to infer one or more measures associated with the behavioural status and/or health status of the rodent at step 820.

The signals detected by the lid interaction sensor can be processed according to a number of different example methods in order to obtain one or more measures associated with the behavioural and/or health status of the rodent. Various example and non-limiting processing methods are henceforth described.

In one example embodiment, the signals obtained from the lid interaction sensor can be processed such that a sufficient change in signal above some determined threshold value is considered a positive interaction. In the case of capacitive measurement scheme described above, cage lid interaction increases the time required for the processor to change from output to input state. Using a thresholding approach, an increase in the time for a state change above a pre-selected value can be considered as a true cage lid interaction. This threshold may be modified for a given cage, animal, or animal health state, as necessary. In another example implementation in which the lid interaction sensor is a weight sensor (as described below), a threshold signal (corresponding to a threshold weight) may be employed to determine signals that are associated with hanging behaviour of a rodent.

The analysis of the lid interaction signals could be used to distinguish different forms of interaction with the cage lid by analyzing the frequency and/or duration of the signals recorded. Lid interaction sensing devices may thus provide both a direct measure cage lid interaction as well as an indirect measurement of rodent hanging and feeding behaviour. The pattern of interaction recorded by the device may also be analyzed to statistically differentiate and identify cage lid interaction by different rodents in the same cage.

Various processing methods may be employed to correlate lid interaction signals with different types of rodent behaviour. Rodent hanging and eating behaviour, which also relies on interaction with the cage lid as food is removed from the hopper, can be determined from an analysis of the output signals and distinguished by their temporal (frequency) characteristics. The distribution of hanging and feeding behaviour over time can provide relevant information on other behaviour of the animal, such as circadian rhythm and therefore indirectly, sleep.

In one example implementation, the time-averaged rate of interaction, or one or more other time-dependent measures associate with the rate of interaction of a rodent with the cage lid, may be employed to determine a behavioural status and/or health status of a rodent based on known or predetermined correlations between the measures and behavioural or health conditions (e.g. pain, disease states, injury, infection, or other pathologies).

In another example embodiment, the signals detected by the lid interaction sensor may be analyzed by a frequency analyzer (e.g. a Fast Fourier Transform) to measure fluctuating output from the sensors. Rodent interaction with the cage lid, either as hanging, eating, or other behaviour, may produce characteristic fluctuations in the recorded values from the cage lid sensors (e.g. fluctuations in lid capacitance). The output from the sensors can therefore be analyzed by a Fourier function to measure the signal's principal frequencies that correspond to different types of cage lid interaction. The transformed values can also be employed to reject out-of-band signals associated with noise. In another example implementation, the spectral content of the transformed signals may be employed to determine a behavioural status and/or health status of a rodent based on known or predetermined correlations between spectral content of the transformed signals and behavioural or health conditions (e.g. pain, disease states, injury, infection, or other pathologies).

In another example embodiment, an adaptive neural network algorithm can also be employed to analyze the output from the lid interaction sensor with the aid of a video recording of the mouse behaviour in which the various behaviours of the mouse have been classified and coded. The behavioural data from the coded video can be used to train the neural network to successfully classify the output from the sensors into different types of cage-lid interaction, such as hanging vs eating. Once the neural network has been trained, sensory input can be analyzed without the need for continual training by data from coded videos.

For example, a machine learning algorithm can be employed to analyze the output from the sensors with the aid of a video recording of the mouse behaviour. In this example, one or more video cameras are used to record the activity of a mouse in a cage. The various actions and postures of the rodent over time are analyzed by software such as Etho Vision XT, HomeCageScan, or ANY-maze to produce a time-indexed list of the mouse behaviours over the course of the video. The list of time-indexed behaviour from the video analysis serves as the training data for the machine learning algorithm. The machine learning algorithm compares the time-indexed coded behaviours from the video with one or more parameters the time-indexed output from the cage lid monitoring device, such as signal value, frequency, or variability, to assign behavioural labels to different patterns of output from the lid monitoring device. The machine learning algorithm may employ deep learning, neural network, or other processes for the purposes of this comparison and training. After the algorithm has been trained to classify output from the device as distinctive behaviours such as hanging or feeding, the algorithm can then be employed in real time to monitor and analyze cage lid interactions.

In embodiments in which the lid interaction sensor is capable of measuring weight of a rodent hanging from the cage lid, the detection of cage lid weight permits the acquisition of further information about the rodent and its behaviour and allows continual monitoring of animal weight. Changes in the weight of the lid after eating episodes, where food is removed from the lid food hopper may also be used to continuously monitor total food consumption. As noted above, in some embodiments, the lid interaction sensor signals

may be processed in order to infer the presence of one or more behavioural or health disorders or pathologies. Many types of behaviour that can be deduced from the output of the cage lid sensors (e.g., hanging, eating, circadian rhythm) are sensitive to physiological and psychological state of the rodent and will change in states of distress. Decreases in cage lid interaction may accompany neurological disorders, cancer progression, cardiovascular disorders, infection, injury, or other immunological disorders including transplant rejection. The pattern of change in hanging behaviour and/or eating behaviour and/or circadian rhythm as determined by an analysis of the cage lid sensor output may change based on the type of disease or pathology underlying the change in behaviour. The output from the sensors may therefore be analyzed to detect changes in cage lid interaction over time that are indicative of distinct underlying pathologies. An algorithm could be employed to detect and flag sudden changes in cage lid interaction after a planned insult, such as surgery, or continuously to detect spontaneous conditions such as skin abscesses that often occur in laboratory mice. In this example, a sudden change in cage lid interaction could be indicative of poor outcomes after surgery. Similarly, spontaneous changes in rodent weight as detected from outputs of embodiments incorporating pressure or weight sensors may also be used to determine pathological conditions.

For example, the cage lid interaction monitoring device may also be useful for diagnosing certain disorders, particularly those associated with motor dysfunction. Disease models such as rodent models of Parkinson's disease, seizure, stereotypy, or dystonia, may alter the manner in which the rodent interacts with the cage lid. The analysis of data from the cage lid interaction device may therefore reveal and classify these changes as indicative of specific disease states. For example, the characteristic shaky motor activity seen in animal models of Parkinson's disease may produce distinctive oscillations in cage lid interaction that can be detected and interpreted as Parkinsonian.

The present device may also be employed in the long-term, non-invasive, and automated measurement of eating and hanging behaviour to facilitate the study of sensory disorders (including persistent pain), motor disorders (such as Huntingtons's disease and ALS), and cancer and chemotherapy; but also other mouse models of disease with proven or suspected alterations in activity or eating behaviour such as cognitive disorders (including Alzheimer's disease, depression, and anxiety), obesity and diabetes, and “sickness behaviour” that is induced by exposure to infectious agents. This example embodiment disclosed herein may also be useful for the large-scale screening of drugs with effects on activity or food intake.

In some example embodiments, lid interaction signals may be detected in the presence of more than one rodent within a rodent cage. In some example embodiments, the identification of individual rodents may be achieved via analysis of the signals in order to correlated signals with specific rodents. For example, in implementations in which weight or pressure sensors are employed, the monitoring of rodent weight may also permit the distinguishing of individual rodents. Neural networks may also be trained with the aid of coded behavior from video analysis to distinguish cage lid interaction by different rodents on the basis of frequency other characteristics of the output from the cage lid sensors (as described above).

In some example implementations, rodents being monitored according to the lid interaction sensing systems, methods and devices disclosed herein can be injected with a substance (e.g. light- or electrical-, or magnetic-sensitive drug or substance), implanted with prosthesis, or otherwise chemically or physically altered or manipulated to facilitate the detection of rodent interaction with the cage lid via a suitable detection modality. The modifications to the animal may improve the detection sensitivity of cage lid interaction or facilitate the identification of individual animals, either directly or via statistical analysis of the information from the cage lid device. For example, rodents may be fitted with a magnetic or electrically-charged cuff to enhance detection of the rodent near the cage lid. In one example embodiment, the sensing device may also contain a radio-frequency identification detector for the detection of RFID chips implanted in the rodents, for the purpose of rodent identification or tracking, or to facilitate the monitoring and differentiation of the activity of multiple rodents in the same cage.

Although some of the preceding embodiments pertain to rodent cages configured for housing mice, it will be understood that the example embodiments of the present disclosure may be adapted and applied for use with a wide range of animals, as cage interactions are expected to be correlated with behavioural or health measures for a wide range of species. For example, aspects of the present disclosure may employed for use with rodents such as, but not limited to, mice, rats, gribbles, hamsters and degus, as such rodents are known or expected to interact with their cage lid when they are accessing food or water and when they move around the cage, and such interactions may be correlated with behavioural or health status. In addition, various embodiments of the present disclosure may also be applied to the behavioral monitoring of non-rodent animals that are housed within cages and interact with the cage lid of their cage, through hanging behaviours or other behaviours.

### EXAMPLES

The following examples are presented to enable those skilled in the art to understand and to practice embodiments of the present disclosure. They should not be considered as a limitation on the scope of the disclosure, but merely as being illustrative and representative thereof.

The present example describes some non-limiting example methods of processing the lid interaction signals. According to the present example embodiment, the lid interaction sensing device employs a circuit for measuring capacitance as described in FIG. 5A-B. A constant-current source continually charges the capacitive sensor to a set threshold value. The time required to charge the capacitive sensor to the threshold value is dependent on the capacitance of the cage lid, which is increased when a rodent makes contact with the lid. A comparator pulses high when the threshold value is reached, after which the capacitor is discharged. The time required to reach threshold is recorded by a reference clock, which is also reset when the threshold is reached.

The maximum number of cycles of capacitance measurement is determined by the time required to charge the capacitive sensor to threshold, and the measurement frequency is set by the program. In the present example, a measurement frequency of 20 Hz is employed. At the end of each measurement cycle, a decimal value of the time required to reach the threshold value on the capacitive sensor is computed on the device microprocessor and output to a computer by means of a wireless connection. The collected data are stored and processed by the computer in real-time.

In the present example, the data output from the device are be analyzed using a thresholding approach to determine the behaviour underlying the cage-lid interaction. In this analysis, several parameters of the output data are compared against a preset threshold, and values above this threshold are considered indicative of particular behaviours. There are three main types of measurable behaviors that are detectable using the device: hanging, feeding/drinking and stretching/rearing. These behaviors can be distinguished based on the duration of interaction, i.e. stretching/rearing behaviors are short as opposed to feeding which is much longer. Specifically, feeding behaviors have been found to last between 30 seconds to several minutes, hanging behaviors last about 2-20 seconds and stretching/rearing behaviors are typically under 1 second in duration.

In combination with, or in alternative to the duration of lid interaction, the frequency of the signal collected by the sensor during the interaction may also be used to distinguish between different behaviors. For example, during hanging behavior, the animal demonstrates sustained contact with the cage lid that will produce a minimally fluctuating signal from the sensor. In contrast, feeding behavior typically involves higher frequency fluctuations in the signal due to repeated breaks in contact with the cage lid. In the simplest form of analysis, the standard deviation of the signal is calculated and used to classify the behaviour underlying the cage lid interaction, with a higher standard deviation measured during transient interactions and lower standard deviation observed during sustained contact.

Additionally, the sensor output can be processed to determine the signal frequency components using fast Fourier transformation or wavelet analysis.

These analysis may be employed, for example, to provide the a composite measure based on the duration and magnitude of the signal from the sensor, the standard deviation of the signal, and/or the frequency of the signal is created and used to classify the interaction as hanging, feeding, stretching, etc. by comparing the composite score to a table of values corresponding to manually-identified behaviours for which the composite score has been previously determined.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Therefore what is claimed is:

1. An apparatus for behavioural monitoring a rodent, the apparatus comprising:
a rodent cage comprising:
a lower cage portion configured to house a rodent therein; and
a cage lid configured to be received by said lower cage portion;
a lid interaction sensor configured to produce signals associated with interactions of the rodent with said cage lid; and
detection circuitry operably coupled to said lid interaction sensor for detecting the signals produced by said lid interaction sensor, wherein said detection circuitry is supported by said rodent cage;
wherein said detection circuitry is connectable to a power source for providing power thereto.

2. The apparatus according to claim 1 wherein at least a portion of said cage lid is an electrically conductive portion, and wherein said lid interaction sensor is a capacitive sensor in electrical communication with said electrically conductive portion of said cage lid.

3. The apparatus according to claim 1 wherein said lid interaction sensor is selected from the group consisting of an optical sensor, a displacement sensor configured to produce a signal based on displacement of said cage lid, a vibration sensor configured to produce a signal based on vibration of said cage lid, a thermal sensor configured to detect the presence of the rodent proximal to said cage lid, and a force sensor positionable between said cage lid and said lower cage portion.

4. The apparatus according to claim 1 further comprising one or more additional lid interaction sensors, wherein each lid interaction sensor is configured to detect interactions of the rodent with a different region of said cage lid.

5. The apparatus according to claim 4 wherein said lid interaction sensors are capacitive sensors, and wherein the different regions of said cage lid are different electrically conductive regions that are electrically isolated, and wherein said each different electrically conductive region is in electrical communication with a different lid interaction sensor.

6. The apparatus according to claim 1 wherein said detection circuitry is supported such that said detection circuitry resides adjacent to a front wall of said lower cage portion.

7. The apparatus according to claim 1 wherein said detection circuitry resides within a recessed portion of said cage lid.

8. The apparatus according to claim 1 wherein said rodent cage further comprising a top cover placed over said cage lid, wherein said detection circuitry is supported by said top cover.

9. The apparatus according to claim 1 further comprising a wireless transmitter operably coupled to said detection circuitry for wirelessly transmitting the signals to a computing device.

10. The apparatus according to claim 9 further comprising:
a wireless receiver for wirelessly receiving one or more behavioural measures from the computing device, the one or more behavioural measures having been generated based on the transmitted signals; and
a display for displaying information associated with the behavioural measures;
wherein said display is supported adjacent to a front wall of said lower cage portion.

11. The apparatus according to claim 1 further comprising:
processing circuitry operably coupled to said detection circuitry, the processing circuitry comprising memory coupled with one or more processors to store instructions, which when executed by said one or more processors, causes said one or more processors to process the detected signals and determine one or more behavioural measures associated with the rodent housed in said apparatus; and
a display for displaying information associated with the behavioural measures;
wherein said display is supported adjacent to a front wall of said lower cage portion.

12. A method of performing behavioural monitoring of a rodent within a rodent cage comprising a cage lid, the method comprising:
detecting, with a lid interaction sensor proximally positioned relative to the cage lid, signals responsively produced based on interactions of the rodent with the cage lid; and
processing the signals to infer one or more behavioural measures associated with behaviour of the rodent.

13. The method according to claim 12 wherein the rodent cage is housed within a cage rack while detecting the interactions with the lid interaction sensor, thereby permitting behavioural monitoring of the rodent without having to remove the rodent cage from the cage rack.

14. The method according to claim 12 wherein the lid interaction sensor is a capacitive sensor that is connectable to an electrically conductive portion of the cage lid.

15. The method according to claim 12 further comprising detecting signals from one or more additional lid interaction sensors, wherein each lid interaction sensor is positioned to detect signals from a different region of the cage lid.

16. The method according to claim 12 wherein the lid interaction sensors are capacitive sensors, and wherein the different regions of the cage lid are different electrically conductive regions that are electrically isolated, and wherein the each different electrically conductive region is in electrical communication with a different lid interaction sensor.

17. The method according to claim 12 wherein the lid interaction sensor is selected from the group consisting of an optical sensor, a displacement sensor configured to produce a signal based on displacement of said cage lid, a vibration sensor configured to produce a signal based on vibration of said cage lid, a thermal sensor configured to detect the presence of the rodent proximal to said cage lid, and a force sensor positionable between the cage lid and a lower cage portion.

18. The method according to claim 14 wherein the signals are processed to detect time-dependent hanging behaviour of the rodent.

19. The method according to claim 14 wherein the signals are processed to determine time-dependent changes in the weight of the rodent.

20. The method according to claim 12 wherein the signals are processed to infer a heath status of the rodent cage according to a frequency of interaction with the cage lid.

21. The method according to claim 12 further comprising modifying the rodent in order to increase a sensitivity of detection of interaction with the cage lid.

22. The method according to claim 12 further comprising:
recording a plurality of video images of the interior of the rodent cage when a plurality of rodents are present within the rodent cage;
processing the video images to separately track a time-dependent location of each rodent; and
processing the time stamps of the signals and the time-dependent locations to identify, for each signal, which rodent was interacting with the cage lid, thereby obtaining rodent-correlated signals associating each signal with a specific rodent of the plurality of rodents; and
wherein the rodent-correlated signals are processed to infer one or more behavioural measures associated with behaviour of each rodent.

23. A sensing module for use with a rodent cage for monitoring interactions of a rodent with a cage lid of the rodent cage, said sensing module comprising:
a lid interaction sensor configured to produce signals associated with interactions of the rodent with the cage lid; and
detection circuitry operably coupled to said lid interaction sensor for detecting the signals produced by said lid interaction sensor;
securing means for securing said detection circuitry and said lid interaction sensor to the rodent cage such that said lid interaction sensor is located proximal to the cage lid; and
wherein said detection circuitry is connectable to a power source for providing power thereto.

24. A sensorized cage lid configured for use with a rodent cage for behavioural monitoring of a rodent, the sensorized cage lid comprising:
a lid body configured to contact a lower cage portion of the rodent cage, said lid body replacing a non-sensorized lid of the rodent cage;
a lid interaction sensor supported by said lid body, wherein said lid interaction sensor is configured such that when said lid body received by the lower cage portion, said lid interaction sensor produces signals associated with interactions of the rodent with said lid body; and
detection circuitry supported by said lid body and operably coupled to said lid interaction sensor for detecting the signals produced by said lid interaction sensor;
wherein said detection circuitry is connectable to a power source for providing power thereto.
